(19) United States
(12) Patent Application Publication
(10) Pub. No.: US 2004/0230554 A1
(43) Pub. Date: Nov. 18, 2004

(54) Method of adding data in bulk to a spatial database

(76) Inventors: Ning An, Nashua, NH (US); Ravi Kanth V. Kothuri, Nashua, NH (US); Siva Kumar Ravada, Nashua, NH (US)

Correspondence Address: DITTHAVONG & CARLSON, P.C., Suite A, 10507 Braddock Rd, Fairfax, VA, 22032, US

(21) Appl. No.: 10/643,359

(22) Filed: Aug. 19, 2003

Related U.S. Application Data
(60) Provisional application No. 60/470,680, filed on May 15, 2003.

(51) Int. Cl. G06F 7/00

(52) U.S. Cl. 707/1

(57) ABSTRACT

A method and software for bulk insertion of data into a spatial or other multidimensional-keyed index are described that includes partially reorganizing the selected portions of the index while inserting data in bulk. In one implementation using an R-Tree, whenever new data are inserted into the entries of a node, potentially overlapping entries of a node can be treated as a big cluster node and reorganized to reduce the overlap of bounding boxes among entries in the big cluster node.

### RELATED APPLICATIONS

The present application claims the benefit of U.S. Provisional Patent Application Serial No. 60/470,680 filed on May 15, 2003 (attorney docket number 50277-1070), the contents of which are hereby incorporated by reference.

### FIELD OF THE INVENTION

The present invention relates to spatial database systems and more particularly to a method of adding data in bulk to a spatial database.

### BACKGROUND OF THE INVENTION

Spatial data describes the shape and location of objects within a space. The space can be for example, a two-dimensional abstraction of the surface of the earth, a man-made space such as the layout of a Very Large Scale Integration (VSLI) design, or a volume containing a model of the human brain. Spatial data objects often cover areas in multi-dimensional spaces and are not well represented by point locations. For example, map objects like counties and census tracts occupy regions of non-zero size in two dimensions.

Spatial databases contain spatial data and are used in many sectors such as census, environmental and urban planning, and telecommunications. Spatial applications are programs, for example, computer aided design (CAD) and geographical analysis, and a common operation in these and other applications is to search for all objects within a specified area. Accordingly, there is a pressing need to retrieve objects efficiently according to their spatial location.

FIG. 1 illustrates spatial objects in an exemplary spatial database. Objects in a spatial database, such as object 101, can have a complex shape, so spatial objects are often approximated by simpler objects. One approximation of the shape of a spatial object is a bounding box, which is a shape that completely encloses the area of the spatial object. For example, object 101 is completely enclosed by bounding box 103. In many spatial database systems, the bounding box is implemented as a minimum bounding rectangle (MBR), which is the smallest n-dimensional rectangle that includes the entire space of the object. In FIG. 1, other bounding boxes for spatial objects are shown as bounding boxes 105, 107, 109, 111, 113, 115, 117, and 119. Sometimes a minimum bounding rectangle of one object can overlap a minimum bounding rectangle for another object; for example, bounding boxes 117 and 119 overlap.

In a database system, indexes are used to increase the speed of data retrieval. A database index is conceptually similar to a normal index found at the end of a book, in that both kinds of indexes comprise an ordered structure of information accompanied with the location of the information. Key values are maintained separately from the actual database table and stored in the index. A spatial index uses multidimensional keys and by using a spatial index, a spatial database system can retrieve particular spatial objects based on positions given by multidimensional coordinates without having to scan the entire set of objects in the spatial index.

One index structure for spatial data is an R-Tree, which is a height-balanced tree similar to a B-tree with index records in its leaf nodes containing pointers to data objects. FIG. 2 depicts an exemplary three level R-tree 200 constructed for the spatial objects illustrated in FIG. 1. Each node of an R-Tree store a number of entries, and each entry comprise a bounding box and a pointer to a spatial object or another R-Tree node. The objects pointed to by the entries of a node are often referred to as the “children” of the node, and a leaf node is an node whose children are spatial objects rather than a sub-node in the R-tree.

For example, the R-Tree 200 has a root node 201 that holds two entries. The first entry of the root node 201 contains the bounding box 129 and a pointer to a node 203. The second entry contains the bounding box 131 and a pointer to a node 205. Nodes 203 and 205 are the children of node 201. Similarly, the node 203 contains two entries, where the first entry of the node 203 contains the bounding box 121 and a pointer to a child node 207, and the second entry of the node 203 contains the bounding box 123 and a pointer to a node child 209. The node 205 contains two children, which are node 211 (characterized by the bounding box 125) and node 213 (characterized by bounding box 127). Although the nodes of the R-Tree 200 are shown to contain between two and three entries for purpose of illustration, implementations generally maintain more entries per node, for example, between 10-32 entries per node.

Entries at the leaf (bottom most level) contain the bounding box of an actual object and reference to the object. For example, the leaf node 207 contains two entries, wherein the first entry of the leaf node 207 contains the bounding box 103 and a pointer to the object 101 that the bounding box 103 encloses and the second entry of the leaf node 207 contains a pointer to an object and the bounding box 105 for the object. Likewise, Leaf node 209 contains two entries, characterized by bounding boxes 107 and 109; leaf node 211 contains entries characterized by bounding boxes 111 and 113; and the leaf node 213 has entries with the bounding boxes 115, 117, and 119.

Spatial indexes, including R-Trees and other data structures, are used to facilitate searching for objects in a spatial database based on a multidimensional key. For example, a search query may request all objects that enclose a point 133. In the example of the R-Tree 200, the search for an object enclosing point 133 starts at the root node 201, which has two entries characterized by bounding boxes 129 and 131, respectively. Point 133 is located in bounding box 129 but not in the bounding box 131, so the node 203 associated with the bounding box 129 is searched while the node 205 associated with the bounding box 131 is ignored. Among the entries of node 203, point 133 resides in the bounding box 121 (associated with node 207) and not within the bounding box 123 (associated with node 209). Accordingly, the node 209 is ignored, and the node 207 is searched. At leaf node 207, the bounding box 103 contains the point 133 and is returned. After finding the bounding boxes in leaf nodes that meet the search criteria, additional computations may be performed to determine if the point 133 lies within the complex object 101 itself. The efficiency of the search is based on the fact that certain areas can be safely ignored when the point does not fall with the bounding box of an object.

Search efficiency degrades, however, when two bonding boxes at the same level in the R-Tree overlap. For example, point 135 resides in entries having overlapping bounding boxes 117 and 119. When a search reaches the node 213, the object 135 resides within the two overlapping bounding boxes 117 and 119, and both entries associated with bounding boxes 117 and 119. This requirement increases the number of entries that have to processed and loses the benefits of being able to exclude areas that can safely be ignored.

Users of spatial databases often find a need to insert a large amount of data into a spatial data at one time. This need arises when the data arrive in batches, or because the users have requested indexing of the spatial database for many individual insertions to be deferred to a later time. A simple way of loading data into an R-Tree is a one-by-one approach, also known as “repeated insertion,” in which each object is loaded one at a time into the R-Tree. This approach exhibits poor performance in terms of Input/Output (I/O) cost, because the R-Tree is repeatedly traversed and many of the nodes, especially those nodes near the root of the R-Tree, are visited multiple times.

One effort to address the disadvantageous performance of the one-by-one approach is known as “Generalized Bulk Insertion” (GBI), which clusters the incoming objects and inserts the clusters into an existing R-Tree. By way of example, FIG. 3 illustrates the insertion of three new objects characterized by bounding boxes 301, 303, and 305, respectively. Using Generalized Bulk Insertion, the new objects are clustered to form a cluster bounded by box 307. With reference now to FIG. 4, a small R-Tree is built from the generated cluster as node 401, which contains entries for the new objects indicated by respective bounding boxes 301, 303, and 305. Node 401 is inserted into a suitable position in the R-tree 400, such as node 203. After insertion of node 401, node 203 contains three entries, of which the third entry contains the bounding box 307 and a pointer to a node 401.

A disadvantage with Generalized Bulk Insertion is that the bounding box for an inserted cluster can heavily overlap the bounding boxes of sibling nodes. In the example illustrated in FIGS. 3 and 4, the bounding box 307 for the cluster inserted in node 203 overlaps with the bounding boxes 121 and 123 of sibling nodes 207 and 209, respectively. This overlap degrades subsequent retrieval performance because multiple nodes (e.g. node 401 with bounding box 301 and node 207 with bounding box 121 for point 101) are required to be searched at various levels of the R-Tree 400. If a query is performed for the object that enclosed point 133, the bounding boxes 121 and 301 both must be searched because they both overlap point 133.

Another approach is referred to as “buffering,” in which the R-Tree spatial index is augmented by a plurality of auxiliary data structures called “buffers” that are associated with respective nodes at specific levels of the R-Tree. Nodes associated with a buffer are called “buffer nodes.” When incoming entries are inserted into an R-Tree using a buffering technique, the entries are descended from the root node until a buffer node, at which point the entries are inserted into the buffer. When the buffer becomes full, the buffer is emptied, and the contents of the emptied buffer are descended from the buffer node among corresponding children of the buffer node, until another buffer node or, ultimately, another leaf node is reached, where the entries are inserted into the leaf node. Although this approach may exhibit better performance than one-by-one repeated insertion, this approach requires large auxiliary date structures whose extra memory requirements may not be feasible in commercial environments.

Therefore, there is a need for a method of adding data to a spatial index in bulk that is not only efficient in terms of insertion performance but which also results in good performance for subsequent queries and does not impose excessive memory costs.

### SUMMARY OF THE INVENTION

These and other needs are addressed by the present invention by partially reorganizing the index while inserting data in bulk. For example, whenever new data are inserted into the entries of a node, potentially overlapping entries of a node can be treated conceptually as a big cluster node and reorganized to reduce the overlap of bounding boxes among entries in the big cluster node.

Accordingly, one aspect of the present invention relates to a method and software for inserting a plurality of entries into an index keyed by multidimensional data, in which subsets of the index (such as two sibling nodes of an R-Tree index) are selected that would overlap if the entries are inserted into the subsets of the index. The entries are inserted within the subsets of the index, and the subsets of the index are reorganized with the inserted entries. Advantageously, reorganizing subsets of the index can reduce overlap in the index and thereby improve subsequent query performance.

Another aspect of the present invention involves a method and software for inserting a plurality of entries into a spatial index, comprising: selecting at least two and less than all children of a node in the spatial index; distributing the entries within the selected children; and reorganizing objects distributed within the selected children. By selecting at least two and less than all children of a node (preferably two), memory requirements can advantageously be controlled.

Yet another aspect of the present invention pertains to a method and software for inserting a plurality of entries into a multidimensional-keyed index organized as an R-Tree, in which a node in the R-tree is associated with a buddy node that is a sibling of the node. Children of the node and the children of the buddy are clustered and partitioned into a plurality of groups, wherein at least one of the groups includes a child node of the cluster node, a buddy child node associated the child node, and one or more of the entries. The one or more of the entries are inserted among the child node and the buddy child node associated the child node.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates spatial objects in an exemplary spatial database.

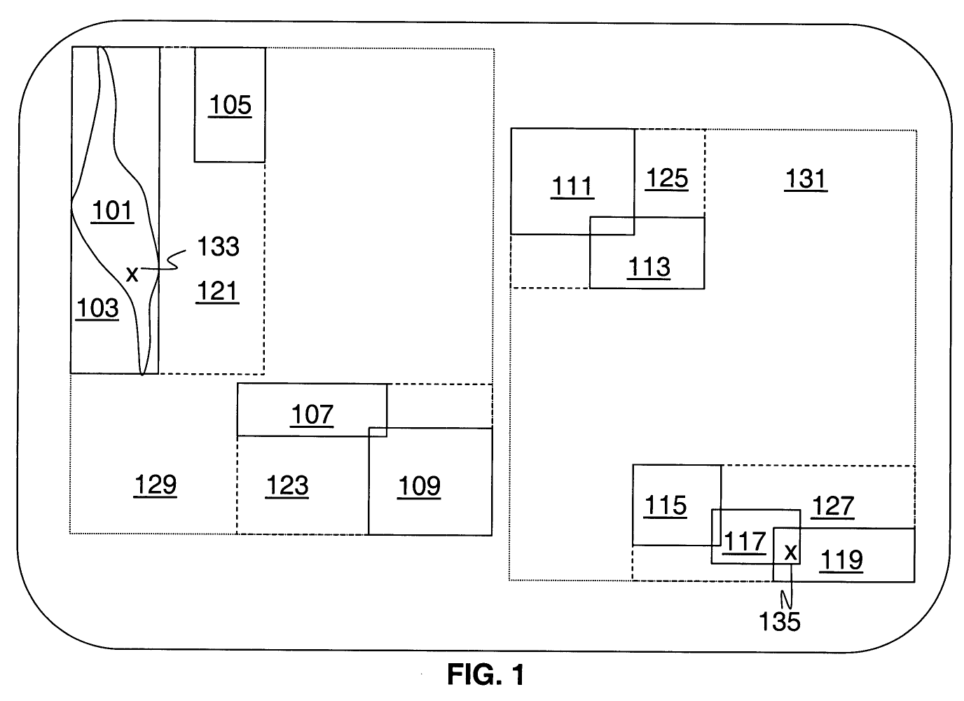

FIG. 2 shows an R-Tree index for the spatial objects in an exemplary spatial database.

FIG. 3 shows a result of inserting data in bulk when using Generalized Bulk Insertion.

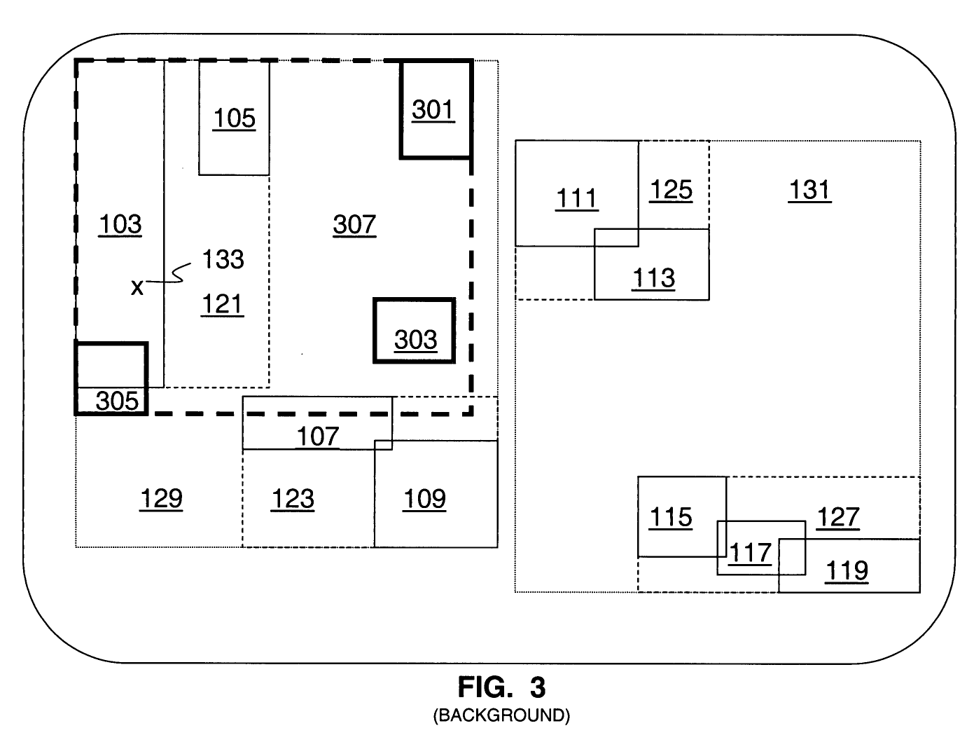

FIG. 4 shows an R-Tree index corresponding to the result shown in FIG. 3.

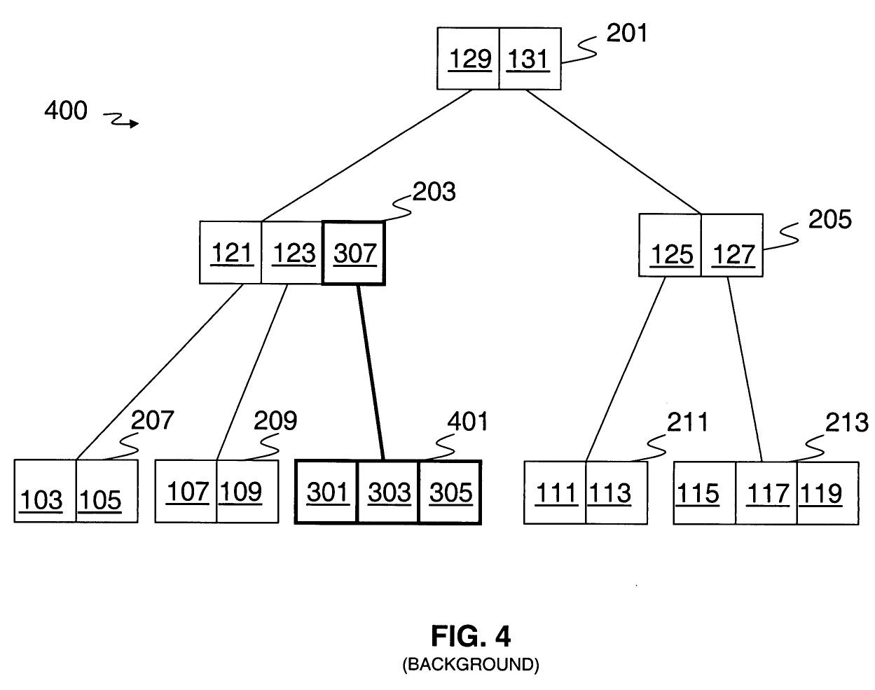

FIG. 5 is a flowchart illustrating the operation of an embodiment of the present invention.

FIG. 6 shows a result of inserting data in bulk in accordance with the embodiment illustrated in FIG. 5.

FIG. 7 shows an R-Tree index corresponding to the result shown in FIG. 6.

### DESCRIPTION OF THE PREFERRED EMBODIMENT

A system, method, and software for inserting data in bulk into a spatial or other multidimensional-keyed index, are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

One aspect of the present invention stems from the realization that whenever new entries are inserted into the child entries of a node in an R-Tree spatial index, the child entries of the node could expand such that the bounding boxes of the child entries may overlap with one another. These overlaps could be avoided if the sub-trees for the child entries are reorganized so that the overlap among the bounding boxes for the child entries are reduced. In one embodiment, to reduce the effort in reorganizing the sub-trees for the child entries, the reorganizing can be focused on sets of potentially-overlapping sub-trees, e.g. sub-trees that would overlap after receiving the new entries. One way to achieve reorganize such sets of potentially-overlapping sub-trees is to treat a potentially-overlapping sub-tree as one big cluster node and reorganize that cluster node.

To limit the working memory size of the big cluster node, the size of the set of potentially-overlapping sub-trees is preferably restricted from all the children, for example, down to two sub-trees. Accordingly, at most two child entries need be associated with one another for inserting the new entries. The entries associated thus with each other may be referred to as “buddy” entries. Thus, a child node and the child node's buddy can be considered a strict subset of their parent node. To further limit the memory usage of the bulk insertion, the procedure for inserting the new entries in bulk can preferably be implemented using recursion or other stack-based technique and by expanding the children in a depth-first fashion. In this way, the memory requirements of the bulk insertion procedure is roughly proportional to the height of the resulting R-Tree, which is generally a logarithm of the number of entries in the R-Tree. In addition, the insertion performance is efficient because each node in the R-Tree need be accessed or updated at most twice.

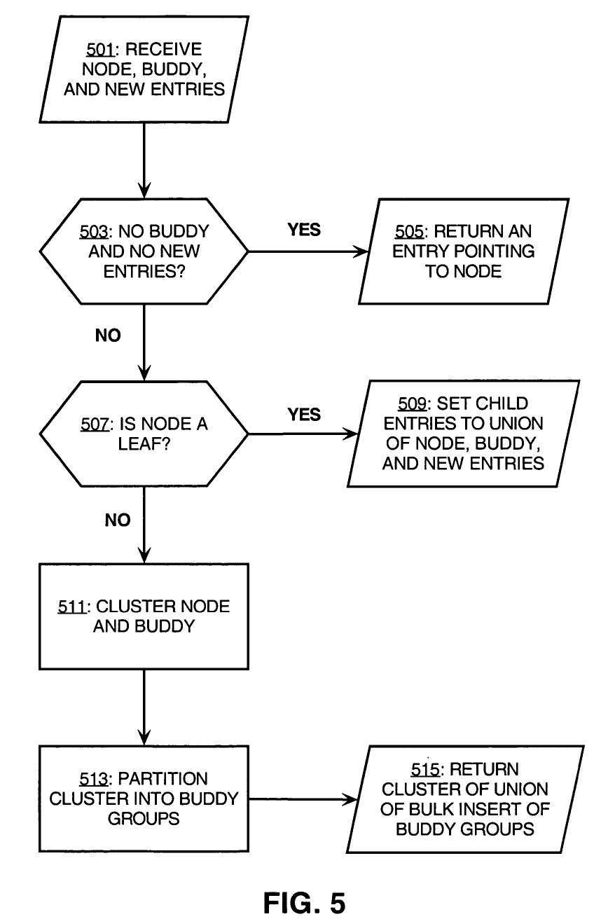

FIG. 5 is a flow chart illustrating the operation of a recursive subroutine used to implement one embodiment of the present invention. At step 501, the parameters of the subroutine are received (as by a function call), which in this embodiment is a current node, an optional buddy node for the current node, and set of zero or more new entries to be inserted. The current node and buddy node are both siblings of one another in the R-tree and preferably overlap or potentially overlap. The buddy node can be null, for example, when there is no other sibling (e.g. at the root) or if there is no qualifying buddy (e.g. no overlapping sibling).

Step 503 handles a base case in the subroutine, in which buddy node is null and there are no new entries to insert into the current node. In this trivial case, the R-tree entry for the current node is simply returned (step 505). Another base case is whether the current node is a leaf node (tested in step 507). If this case is true (i.e. the current node is a leaf node), then a clustering of the entries in the current node, the buddy node, and the new entries is returned (step 509). In one implementation, this can be achieved by setting a child entry list a union of the current node entries, the buddy node entries, and the new entries and calling an R-Tree cluster routine on the child entry list, which produces an array of R-Tree entries that would replace the entries for current node and the buddy node in their parent node.

If, on the other hand, the current node is not a leaf node (tested in step 507) and if the buddy node and the new entries are not both null (step 503), then execution of the subroutine proceeds to step 51 1, where the current node and the buddy node are clustered together to form a union. Then, at step 513, the members of the union of the current node and the buddy node are partitioned in groups to reduce the total overlaps. In one embodiment, each group has at least one child node from the union of the current node and the buddy node, an optional buddy node for the child node, and zero or more of the new entries, chosen such that the total overlap across all the groups is minimized or reduced (for example, by using the Choose Subtree algorithm for an R*-Tree). Furthermore in this embodiment, the groups are chosen so that each of the children of the union is assigned to exactly one of the groups, while a buddy node for a child node need be specified only when there is an overlap in the bounding boxes of the child node and the child node's buddy node. In addition, all of the new entries are distributed among the groups, although some of the groups need not contain any of the new entries.

After the partitioning in step 513, step 517 is executed where a bulk insert is recursively (or, in other implementations, iteratively or otherwise repeatedly) performed on each group and aggregated to obtain a child entry list, which is clustered to produce an array of R-Tree entries to be returned as a replacement of the entries for current node and the buddy node in their parent node.

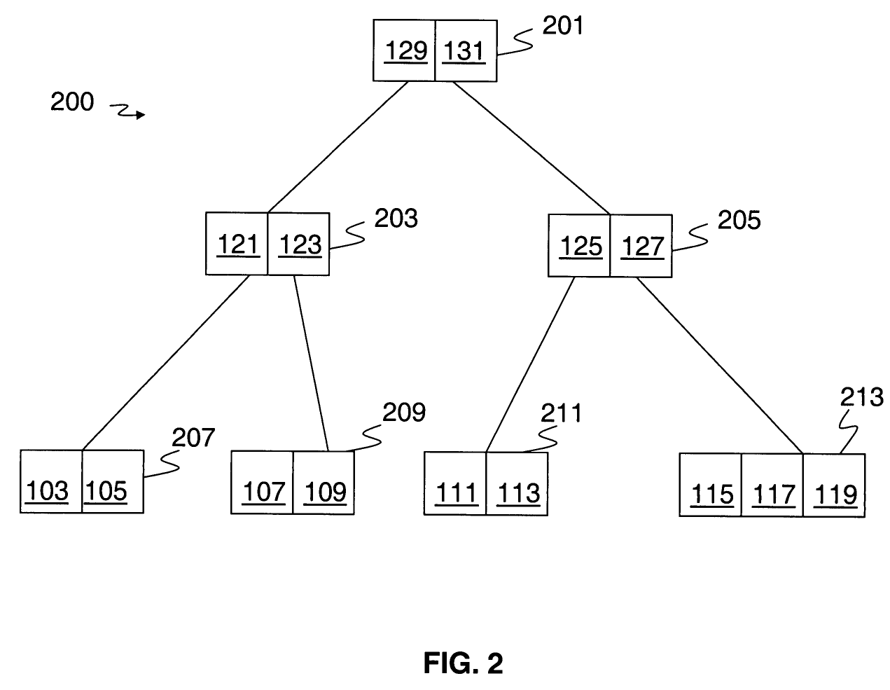

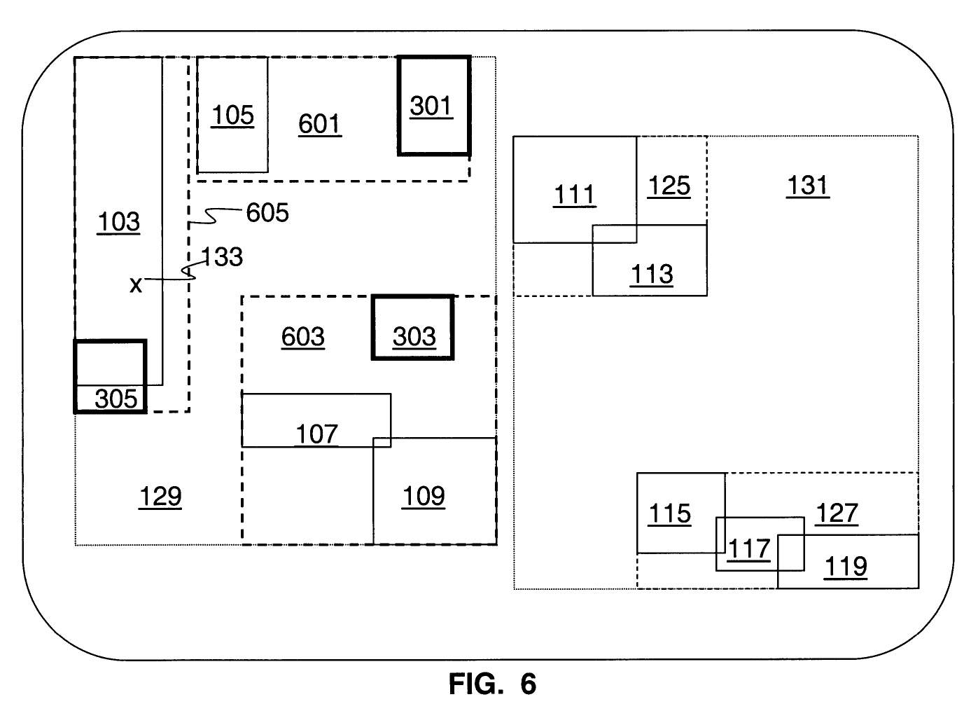

The operation of the bulk insert recursive subroutine shown in FIG. 5 can be illustrated by way of a working example, shown in FIGS. 6, of inserting three new entries having respective bounding boxes 301, 303, and 305 into the R-Tree 200 of FIG. 2.

The bulk insert subroutine can be initially called (step 501) with a current node of 201, a null buddy node, and an entry list of {301, 303, 305 }. At step 503, the entry list of {301, 303, 305 } is not null, so execution proceeds to step 507. Since the current node of 201 is not a leaf node as shown in FIG. 2, step 511 is then executed, in which the current node of 201 (which is subtended by nodes 203 and 205 in FIG. 2) is aggregated with the null buddy node to produce a cluster {203, 205 }. Since nodes 203 and 205 do not overlap, the result of the partitioning step 513 has two groups, of which all the new entries {301, 303, 305 } are distributed to the group with node 203. Accordingly, there are two groups: <203, null, {301, 303, 305 }>and <205, null, { }>, and the bulk insert subroutine is recursively called on each of group.

Invocation of the bulk insert subroutine on the second group <205, null, { }>means that step 501 receives node 205 as the current node, null as the buddy node, and null as the entry list. Because the buddy node is null and the entry list is null, the test in step 503 is affirmative and step 505 is performed where node 205 is simply returned.

Calling the bulk insert subroutine on the group <203, null, {301, 303, 305 }>, however, leads to more processing. Specifically, in step 501, a current node 203, a null buddy node, and an entry list of {301, 303, 305 } are received. Neither of the base cases tested by steps 503 and 507 respectively are triggered, so execution of the bulk insert subroutine reaches step 511, where the entries of node 203 are aggregated to produce a cluster of nodes {207, 209 }. Execution of the partitioning step 513 results in the following group: <207, 209, {301, 303, 305 }>, since nodes 207 and 209 would overlap if entries 301, 303, and 305 were to be inserted among them. Step 515 performs another recursive call of the bulk insert subroutine, this time on the group <207, 209, {301, 303, 305 }>.

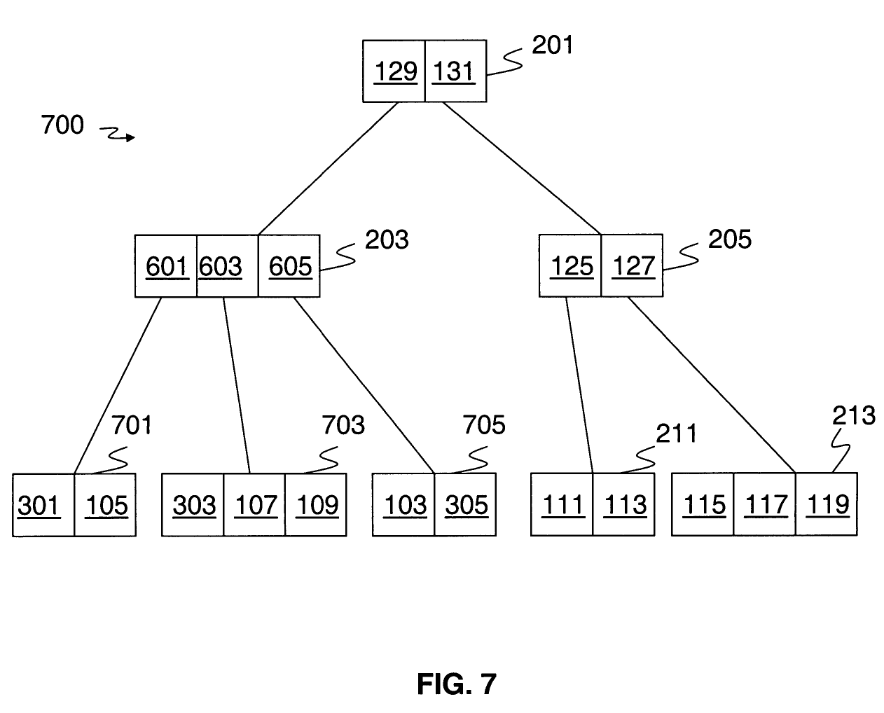

However, this invocation of the subroutine triggers the base case tested at step 507 since node 207 is a leaf node. Accordingly, step 509 is performed to reorganizing the entries for nodes 207 and 209 plus new entries 301, 303, and 305. This step results in a list of entries, which is illustrated in FIG. 7 as comprising node 701 (for a cluster bounded by box 601 of objects with bounding boxes 301 and 105), node 703 (bounded by box 603 for objects bounded by boxes 303, 107, and 109), and node 705 (for objects with bounding boxes 103 and 305 resulting in bounding box 605). These entries 701, 703, and 705 are returned in step 515 and, when the execution returns to the next higher level of recursion, the entries 701, 703, and 705 are used to replace entries 207 and 209 within node 203 at step 515. Step 515 also returns the modified node 203 to the higher level recursive invocation, where it is paired with node 205, and the R-Tree 700 is produced.

Relative to the R-Tree 400 produced by the Generalized Bulk insert approach, subsequent query performance is improved for R-Tree 700 because the overlapping of bounding boxes in the R-Tree 700 is much less than the overlapping of bounding boxes in the R-Tree 400. Specifically, with regard to searching for an object that encloses point 133, only one child node need be searched at each level (i.e. nodes 201, 203, 701, and the object bounded by box 103).

Moreover, the performance of an embodiment of the present invention whose operation is illustrated in FIG. 5 is superior to that of the one-by-one repeated insertion approach. In experiments using real datasets, an improvement in insertion performance by 50-90% over the one-by-one repeated insertion approach has measured. Furthermore, subsequent query performance has also been measured to be better than the one-by-one repeated insertion approach, becoming more noticeable with the increase of incoming data size.

### HARDWARE OVERVIEW

A computer system upon which an embodiment according to the present invention can be implemented includes a bus or other communication mechanism for communicating information and a processor coupled to the bus for processing information. The computer system also includes main memory, such as a random access memory (RAM) or other dynamic storage device, coupled to the bus for storing information and instructions to be executed by the processor. Main memory can also be used for storing temporary variables or other intermediate information during execution of instructions by the processor. The computer system may further include a read only memory (ROM) or other static storage device coupled to the bus for storing static information and instructions for the processor. A storage device, such as a magnetic disk or optical disk, is coupled to the bus for persistently storing information and instructions.

The computer system may be coupled via the bus to a display, such as a cathode ray tube (CRT), liquid crystal display, active matrix display, or plasma display, for displaying information to a computer user. An input device, such as a keyboard including alphanumeric and other keys, is coupled to the bus for communicating information and command selections to the processor. Another type of user input device is a cursor control, such as a mouse, a trackball, or cursor direction keys, for communicating direction information and command selections to the processor and for controlling cursor movement on the display.

According to one embodiment of the invention, inserting data in bulk into a spatial or other multidimensional-keyed index is provided by the computer system in response to the processor executing an arrangement of instructions contained in main memory. Such instructions can be read into main memory from another computer-readable medium, such as the storage device. Execution of the arrangement of instructions contained in main memory causes the processor to perform the process steps described herein. One or more processors in a multi-processing arrangement may also be employed to execute the instructions contained in main memory. In alternative embodiments, hard-wired circuitry may be used in place of or in combination with software instructions to implement the embodiment of the present invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the present invention are not limited to any specific combination of hardware circuitry and software.

The computer system also includes a communication interface coupled to bus 801. The communication interface provides a two-way data communication coupling to a network link connected to a local network. For example, the communication interface may be a digital subscriber line (DSL) card or modem, an integrated services digital network (ISDN) card, a cable modem, a telephone modem, or any other communication interface to provide a data communication connection to a corresponding type of communication line. As another example, communication interface may be a local area network (LAN) card (e.g. for EthernetTM or an Asynchronous Transfer Model (ATM) network) to provide a data communication connection to a compatible LAN. Wireless links can also be implemented. In any such implementation, communication interface sends and receives electrical, electromagnetic, or optical signals that carry digital data streams representing various types of information. Further, the communication interface can include peripheral interface devices, such as a Universal Serial Bus (USB) interface, a PCMCIA (Personal Computer Memory Card International Association) interface, etc. Although Multiple communication interfaces can also be employed.

The network link typically provides data communication through one or more networks to other data devices. For example, the network link may provide a connection through local network to a host computer, which has connectivity to a network (e.g. a wide area network (WAN) or the global packet data communication network now commonly referred to as the “Internet”) or to data equipment operated by a service provider. The local network and the network both use electrical, electromagnetic, or optical signals to convey information and instructions. The signals through the various networks and the signals on the network link and through the communication interface, which communicate digital data with the computer system, are exemplary forms of carrier waves bearing the information and instructions.

The computer system can send messages and receive data, including program code, through the network(s), the network link, and the communication interface. In the Internet example, a server (not shown) might transmit requested code belonging to an application program for implementing an embodiment of the present invention through the network, the local network and the communication interface. The processor may execute the transmitted code while being received and/or store the code in the storage device, or other non-volatile storage for later execution. In this manner, the computer system may obtain application code in the form of a carrier wave.

The term “computer-readable medium” as used herein refers to any medium that participates in providing instructions to the processor for execution. Such a medium may take many forms, including but not limited to non-volatile media, volatile media, and transmission media. Non-volatile media include, for example, optical or magnetic disks, such as the storage device. Volatile media include dynamic memory, such as main memory. Transmission media include coaxial cables, copper wire and fiber optics, including the wires that comprise the bus. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the present invention has been described in connection with a number of embodiments and implementations, the present invention is not so limited but covers various obvious modifications and equivalent arrangements, which fall within the purview of the appended claims.

What is claimed is:

1. A method of inserting a plurality of entries into an index keyed by multidimensional data, comprising:
selecting subsets of the index that overlap if the entries are inserted into the subsets of the index;
inserting the entries within the subsets of the index; and
reorganizing the subsets of the index with the inserted entries.

2. A method according to claim 1, wherein said reorganizing includes reorganizing such that an amount of overlap of bounding boxes for objects in the strict subset of the index is reduced.

3. A method according to claim 1, wherein:
the entries include spatial data; and
the index keyed by multidimensional data includes a spatial index.

4. A method according to claim 1, wherein the subset include sibling nodes of an R-Tree index.

5. A computer-readable medium bearing instructions for inserting the entries into the spatial, said instructions arranged, upon execution by one or more processors, to perform the method according to claim 1.

6. A method of inserting a plurality of entries into a spatial index, comprising:
selecting at least two and less than all children of a node in the spatial index;
distributing the entries within the selected children; and
reorganizing objects distributed within the selected children.

7. A method according to claim 6, wherein said reorganizing includes reorganizing such that an amount of overlap of bounding boxes for objects in the spatial index is reduced.

8. A method according to claim 7, wherein one of the bounding boxes includes a minimum bounding rectangle (MBR).

9. A method according to claim 6, wherein at least two of the selected children have respective bounding boxes that overlap with one another.

10. A method according to claim 6, wherein said selecting includes selecting exactly two of the children.

11. A method according to claim 10, wherein the exactly two of the children have respective bounding boxes that overlap with one another.

12. A method according to claim 6, wherein the object distributed among the selecting children include the entries.

13. A computer-readable medium bearing instructions for inserting the entries into the spatial index, said instructions arranged, upon execution by one or more processors, to perform the method according to claim 6.

14. A method of inserting a plurality of entries into a multidimensional-keyed index organized as an R-Tree, comprising:
associating a node in the R-tree with a buddy node that is a sibling of the node;
clustering children of the node and the children of the buddy;
partitioning the clustered children and the entries into a plurality of groups, wherein at least one of the groups includes a child node of the cluster node, a buddy child node associated the child node, and one or more of the entries; and
inserting said one or more of the entries among the child node and the buddy child node associated the child node.

15. A method according to claim 14, wherein:
each node of the R-tree is associated with a respective bounding box; and
a first bounding box associated with the child node overlaps a second bounding box associated with the buddy child node.

16. A method according to claim 14, where said partition is perform so than overlap among bounding boxes associated with the groups is reduced.

17. A computer-readable medium bearing instructions for inserting the entries into the spatial index, said instructions arranged, upon execution by one or more processors, to perform the method according to claim 14.
